(19) United States
(12) Patent Application Publication
(10) Pub. No.: US 2024/0322494 A1
(43) Pub. Date: Sep. 26, 2024

(54) ELECTRICAL CONNECTOR WITH AN IMPROVED GROUNDING MEMBER

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: JIA-HAU LIU, New Taipei (TW); QIN-XIN CAO, Kunshan (CN); TSU-YANG WU, New Taipei (TW)

(21) Appl. No.: 18/612,078

(22) Filed: Mar. 21, 2024

(30) Foreign Application Priority Data
Mar. 24, 2023 (CN) 202310300498.2

(51) Int. Cl. H01R 13/6471; H01R 13/6581

(52) U.S. Cl. CPC H01R 13/6471; H01R 13/6581

(57) ABSTRACT

An electrical connector includes: a housing defining a longitudinal direction; a row of first terminals being retained in the housing and having plural pairs of signal terminals and plural grounding terminals; a row of second terminals retained in the housing opposite to the row of the first terminals; and a first grounding member retained in the housing, wherein the first grounding member has a longitudinal ridge, plural shielding portions, and plural grounding tails extending from the longitudinal ridge, the shielding portions face and shield corresponding pairs of signal terminals of the row of first terminals, respectively, spanning from a rear end to a front end of corresponding signal terminals, and the grounding tails contact corresponding grounding terminals of the row of first terminals, respectively.

### BACKGROUND OF THE INVENTION

### Field of the Invention

The present invention relates to an electrical connector which transmits high frequency signal.

### Description of Related Arts

U.S. Publication No. 2023/0170649 discloses an electrical connector with a plurality of grounding members, each of the grounding members having a front bar, a rear bar, and plural bridges between the front bar and the rear bar. A plurality of grounding fingers extend from the front bar, the rear bar or the bridges for electrically connecting with ground terminals.

Therefore, it is desired to provide an electrical connector with an improved grounding member.

### SUMMARY OF THE INVENTION

An object of the present invention is to provide an electrical connector with an improved grounding member.

To achieve the above object, an electrical connector comprises a longitudinal housing defining a longitudinal direction; a row of first terminals being retained in the housing and comprising plural pairs of signal terminals and plural grounding terminals; a row of second terminals retained in the housing opposite to the row of the first terminals; and a first grounding member retained in the housing, wherein the first grounding member comprises a longitudinal ridge extending in the longitudinal direction, a plurality of shielding portions, and a plurality of grounding tails extending from the longitudinal ridge, the shielding portions face and shield corresponding pairs of signal terminals of the row of first terminals, respectively, spanning from a rear end to a front end of corresponding signal terminals, and the grounding tails contact corresponding grounding terminals of the row of first terminals, respectively.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of a plug connector and a receptacle connector separated from each other;

FIG. 2 is another perspective view of the plug connector and the receptacle connector of FIG. 1;

FIG. 3 is a cross-sectional view of the plug connector and the receptacle connector taken along line A-A of FIG. 1;

FIG. 4 is a cross-sectional view of the plug connector and the receptacle connector mated with each other;

FIG. 5 is another perspective view of the plug connector of FIG. 1;

FIG. 6 is a bottom view of the plug connector of FIG. 1;

FIG. 7 is an exploded perspective view of the plug connector of FIG. 2, wherein some of the second terminals are separated from the housing;

FIG. 8 is a further exploded perspective view of the plug connector of FIG. 7;

FIG. 9 is a perspective view of the plug connector with the housing and some of the second terminals being removed;

FIG. 10 is a perspective view of plug connector of FIG. 9 with the second terminals all being removed;

FIG. 11 is an exploded perspective view of the receptacle connector of FIG. 1 with the grounding members for contacting with the second terminals separated from the receptacle connector;

FIG. 12 is a further exploded view of the receptacle connector;

FIG. 13 is another exploded perspective view of the receptacle connector of FIG. 12;

FIG. 14 is a perspective view of the second terminals and the grounding members for contacting with grounding terminals thereof of FIG. 12;

FIG. 15 is an exploded view of a first terminal module and grounding members for contacting with the grounding terminals thereof;

FIG. 16 is a perspective view of the first terminal module and a fourth grounding member thereof; and

FIG. 17 is a perspective view of the first terminals and the first grounding member thereof of FIG. 15.

### DETAILED DESCRIPTION OF THE PREFERRED EMBODIMENT

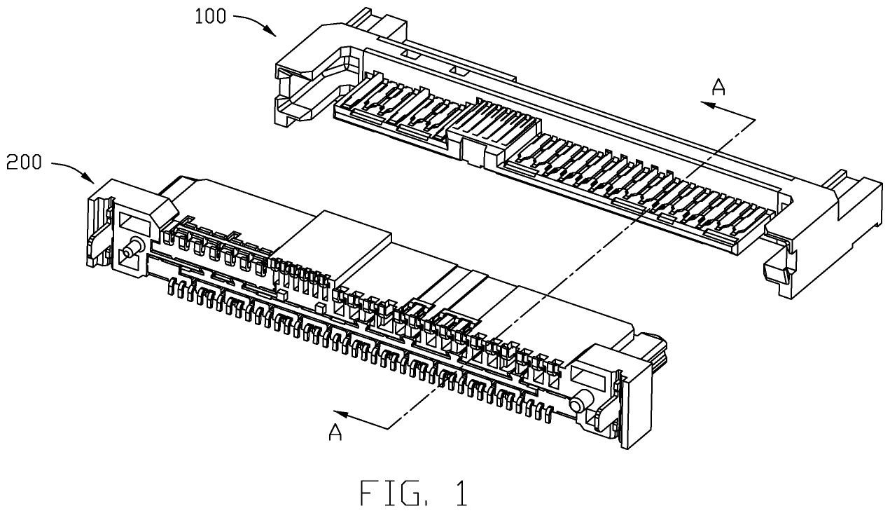

Referring to FIGS. 1-4, an electrical connector assembly with SFF-8639 transmission interface is illustrated, which includes a plug connector 100 and a receptacle connector 200 mated with the plug connector 100. The assembly is adapted for transmitting high speed signals with signal transmission rates above 32GT/s and transmission bandwidth up to 128 GB/s. The assembly can be applied to the latest generation PCIe 5.0 transmission protocol.

For convenience, a mating end of the plug connector 100 or the receptacle connector 200 is defined as a front end.

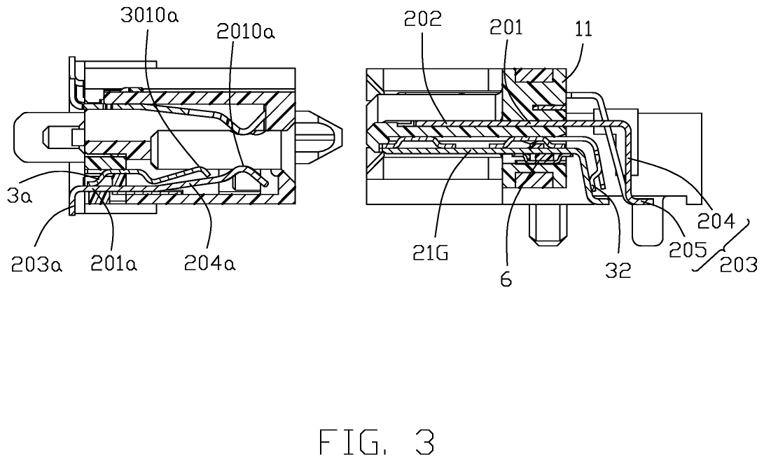

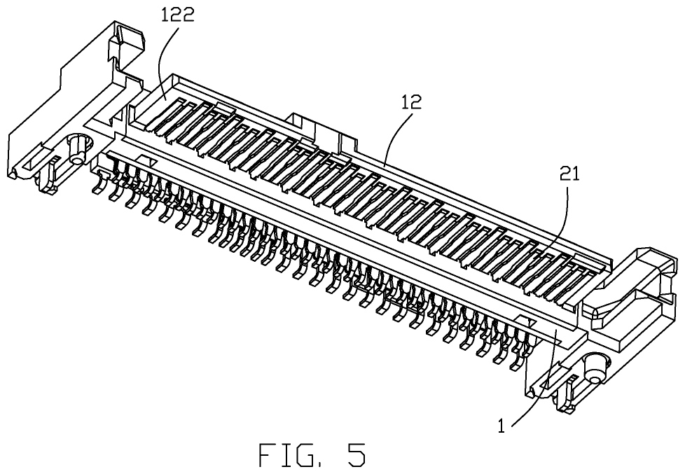

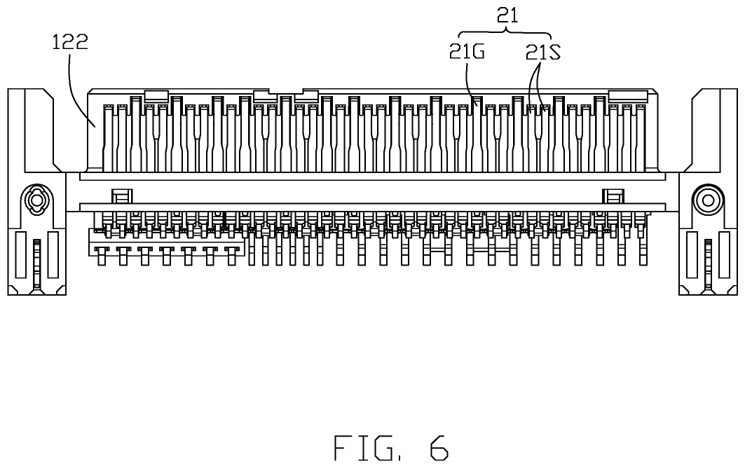

Referring to FIGS. 5-8, the plug connector 100 includes a longitudinal housing 1 made from insulating material, a row of first/lower terminals 21, a row of second/upper terminals 22 and a first grounding member 3, the first terminals 21 and the second terminals 22 are retained on two opposite sides of the housing 1 respectively, and the first grounding member 3 is at one side of the first terminals 21. The housing 1 includes a base portion 11, and a tongue portion 12 extending forward from the base portion and with an upper face 121 and a lower face 122. The upper face 121 is provided with a key 1210. Each of the first terminal 21 and the second terminal 22 have a flat portion, the flat portion of the first terminal 21 is located on the lower face 122 of the tongue portion 12 and the flat portion of the second terminal 22 is located on the upper face 121 of the tongue portion 12. The row of the first terminals 21 includes plural pairs of signal terminals 21S and plural grounding terminals 21G. Combining with FIG. 3, each of the first terminal 21 and second terminal 22 comprises a fixing portion 201 fixed in the base portion 11, the flat portion 202 extending forward from the fixing portion 201 and the tail portion 203 extending backwards from the fixing portion 201. The tail portion 203 comprises a connecting portion 204 extending downwardly from the fixing portion 201 and a soldering portion 205 extending horizontally backward from the fixing portion 201. The housing 1 comprises a first insulating part/an insulating bar 111. The first terminals 21 are molded into the insulating bar 111 firstly to form a first terminal module 210, and then the first terminal module 210 is installed into a main insulating part of the housing 1 composed of the base portion and the tongue portion 12.

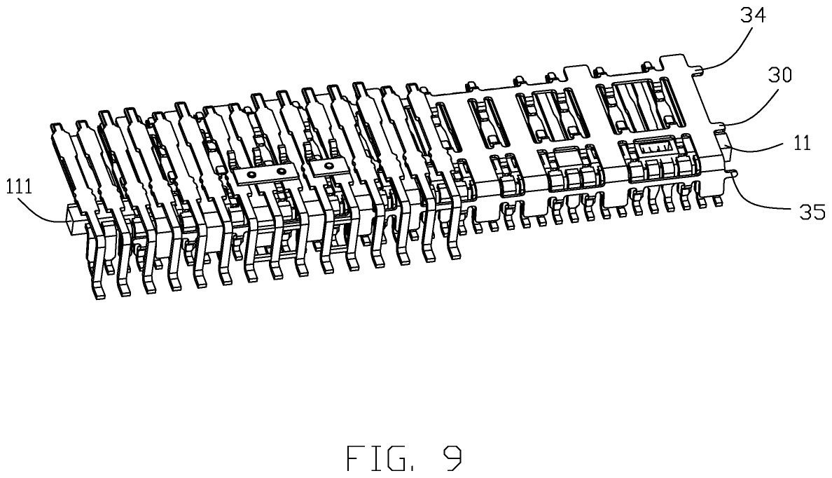

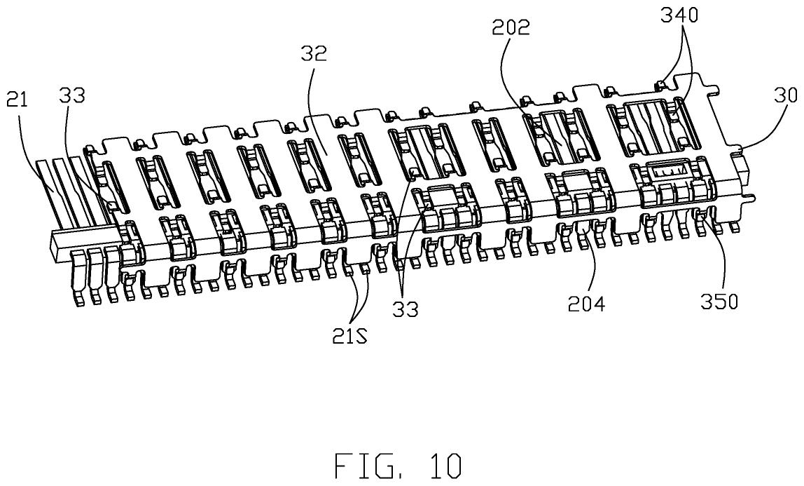

Referring to FIGS. 9-10, the first grounding member 3 comprises a longitudinal ridge 30, a plurality of shielding portions 32 and a plurality of grounding tails 33 extending from the longitudinal ridges 30. Each shielding portion 32 faces a corresponding pair of signals terminals 21S and span from the connecting portion 204 to the front end of the flat portion 202 of the signal terminals 21S. The first grounding member 3 further comprises a front assistant ridge 34 in front of the longitudinal ridge 30 and a rear assistant ridge 35 behind the longitudinal ridge 30. The first assistant ridge 34 has a plurality of grounding tails 340 and the second assistant ridge 35 has a plurality of grounding tails 350. The longitudinal ridge 30 is retained in the base portion 11, the grounding tails 33 extend from two opposite sides of longitudinal ridge 30 and each grounding terminal 21G is grounded at two points along a lengthwise direction thereof with the first grounding tails 33. That means, the grounding tails 33 include front grounding tail and the rear grounding tail. The grounding ridge 30 is arranged and contact with the grounding terminal 21G within the base portion 11 or adjacent to the base portion 11. The front assistant ridge 34 is located near the front end of the tongue portion 12 and united with the shielding portions 32, the grounding tails 340 extend from two sides of the front assistant ridge 34, thus, the grounding tails 340 can get contact with the front end of the flat portion 202 of the grounding terminal 21G. In addition, the rear assistant ridge 35 is located facing the connecting portion 204 of the first terminals 21 and united with the shielding portions 32, the grounding tails 350 extend from the second assistant ridge 35 downwardly and contact with the connecting portions 204 of the grounding terminals 21G. Thus, all the grounding tails 33, 340, 350 of the longitudinal ridge 33, the front assistant ridge 34 and the rear assistant ridge 35 contacting the same grounding terminal 21G of first terminals 21 extend in a lengthwise direction of corresponding grounding terminal. In the prior art US2023/0170649A, as the bridge is over the signal terminals and the grounding fingers extending thereof is in a direction substantially orthogonal to a lengthwise direction of the grounding terminal/the signal terminal, the grounding finger extending from the bridge gets easily incorrect contact with the signal terminals below the bridge when it goes downwardly to get contact with the corresponding grounding terminal. Compared with that, all the grounding tails 33, 340, 350 extending in a direction along the length of the grounding terminal can be avoided to get contact with the signal terminals when they come to get contact with the grounding terminal 21G.

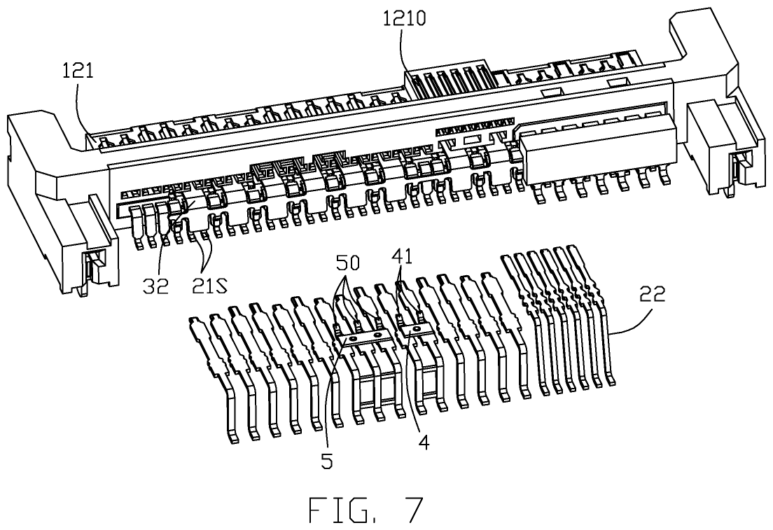

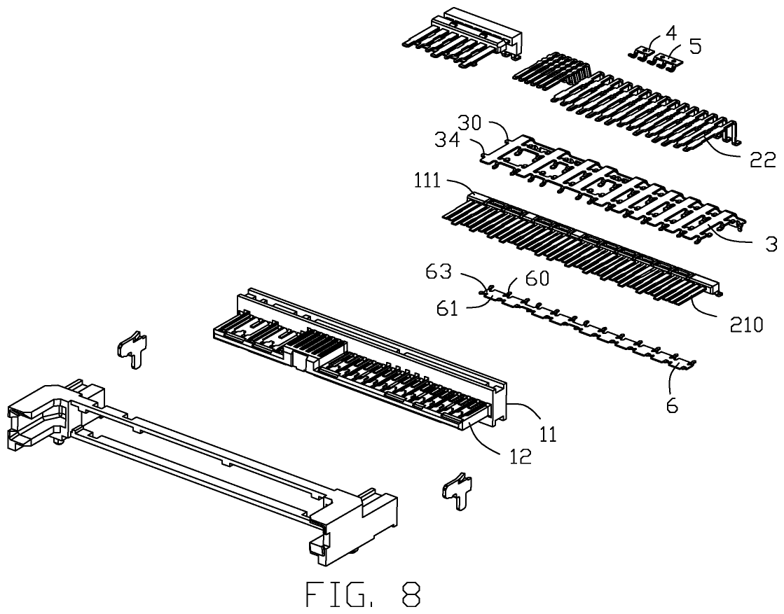

Referring to FIGS. 7-8, the plug connector 100 further includes a second grounding member 4 and a third grounding member 5 that are adjacently arranged along the longitudinal direction. The second grounding member 4 includes two grounding tails 41 which contact with two grounding terminals of the second terminals 22 respectively. The third grounding member 5 comprises three grounding tails 50 which contact with three grounding terminals of the second terminal 22 respectively. Referring to FIGS. 3 and 8, the plug connector 100 further comprises a fourth grounding member 6, the first grounding member 3 is at one side of the row of the first terminals 21 near the row of the second terminals 22, that is, the first grounding member 3 is between the row of the first terminals 21 and the row of the second terminals 22. The fourth grounding member 6 including a longitudinal ridge 63, a plurality of grounding tails 60 and a plurality of shielding portions 61, is at one side of the row of the first terminals 21 away from the row of the second terminals 22. The shielding portion 32 of the first grounding member 3 faces to the corresponding shielding portions 61 of the fourth grounding member 6 one to one, so the shielding portion 32 of the first grounding member 3 and the shielding portion 61 of the fourth grounding member 6 are at two different sides of the pair of the signal terminals 21S of the first terminals 21 respectively. The grounding tails 33 of the first grounding member 3 and the grounding tails 60 of the fourth grounding member 6 are at two different sides of the grounding terminals 21G of the first terminals 21, thus, the grounding terminals 21G can be grounded from its two sides by the grounding tails 33 of the first grounding member 3 and the grounding tails 60 of the fourth grounding member 6. Preferably, the fourth grounding member 6 is retained in the base portion 11.

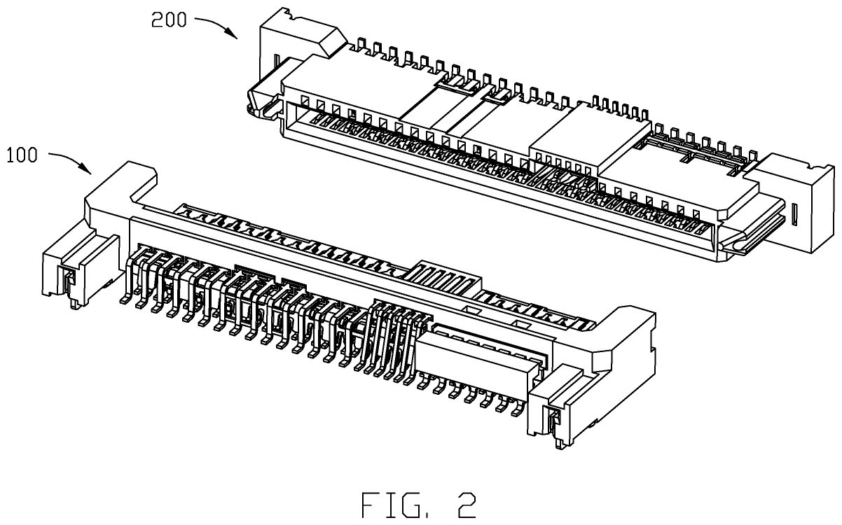

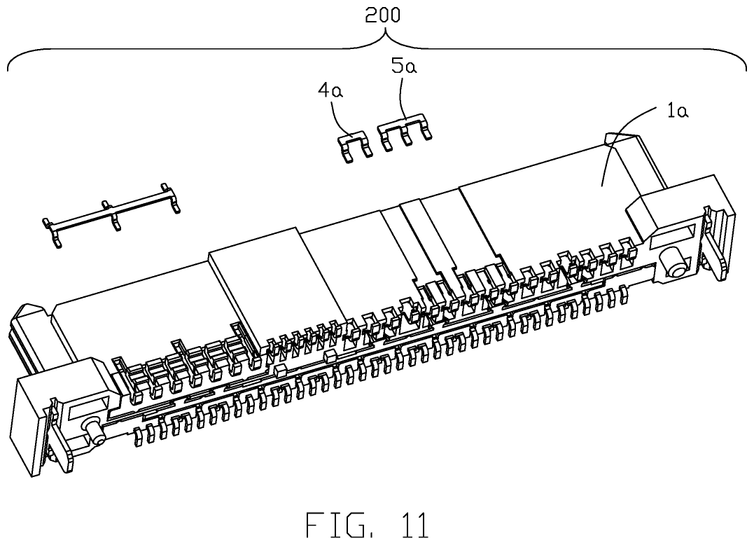

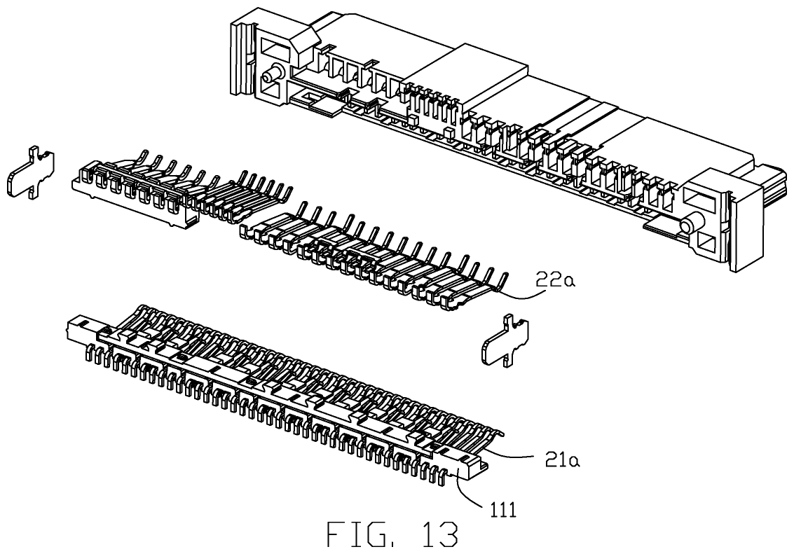

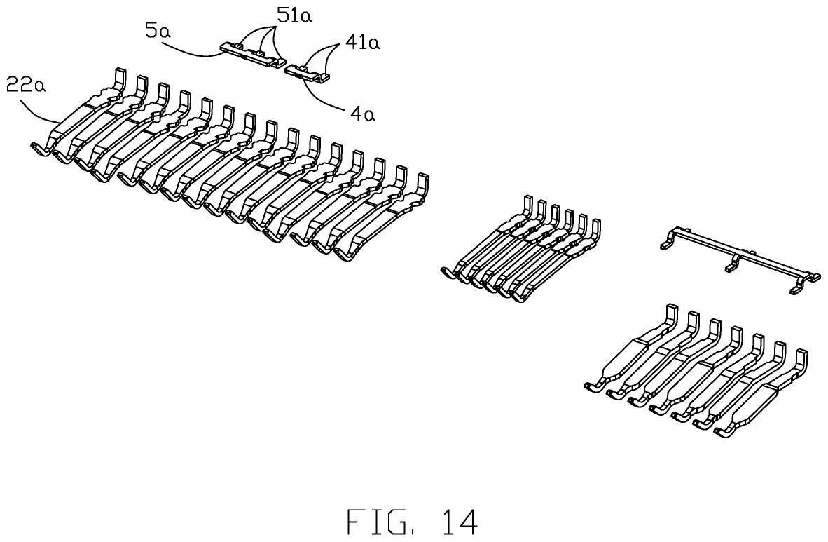

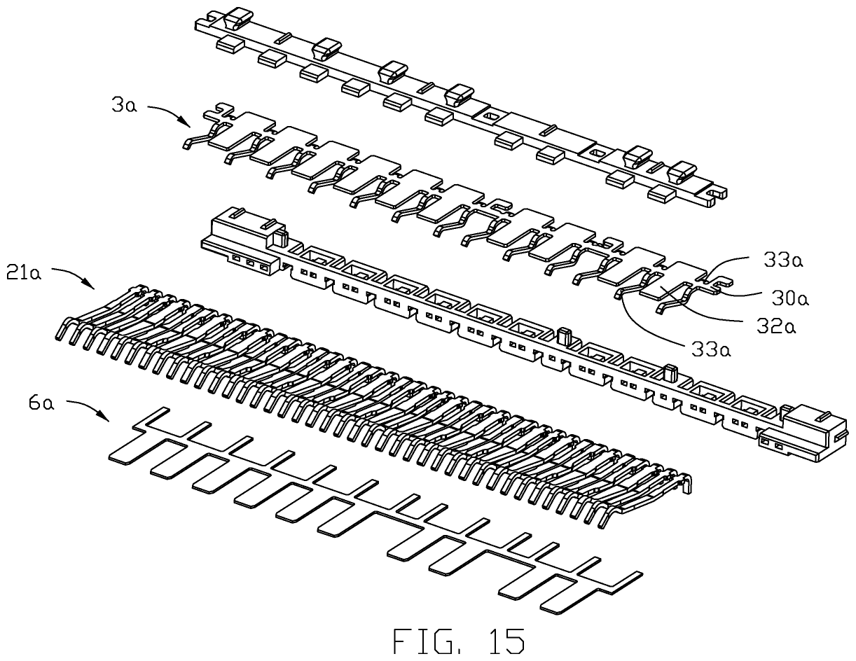

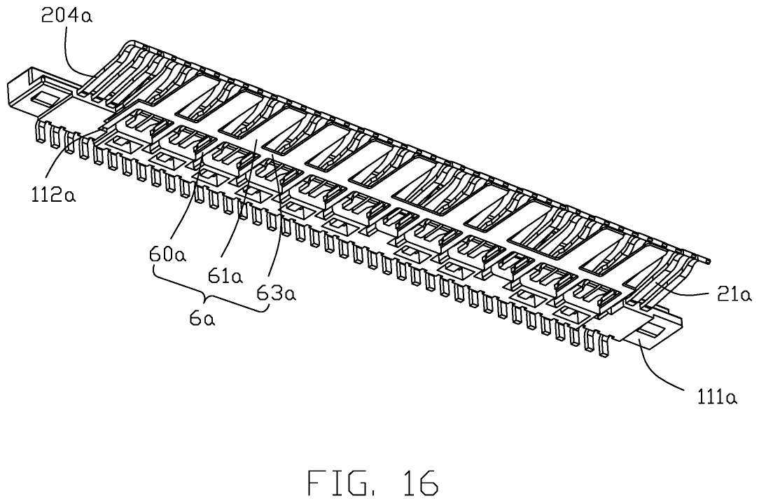

Referring to FIGS. 11-16, the receptacle connector 200 comprises a longitudinal housing 1a, a row of first terminals 21a, a row of second terminals 22a and a first grounding member 3a located at one side of the first terminals 21a. The housing 1a is provided with a mating slot 10, which can be seen clearly in FIG. 2, and two side walls beside the mating slot 10, the row of the first terminals 21a is retained in one side wall and the row of the second terminals 22a is retained in the other side wall. Similar to the plug connector 100, the first terminals 21a are molded into in a first insulating part 111a which is a part of the housing 1a to form a first terminal module 210 firstly and then the first terminal module 210 is installed into a main part of the housing 1a.

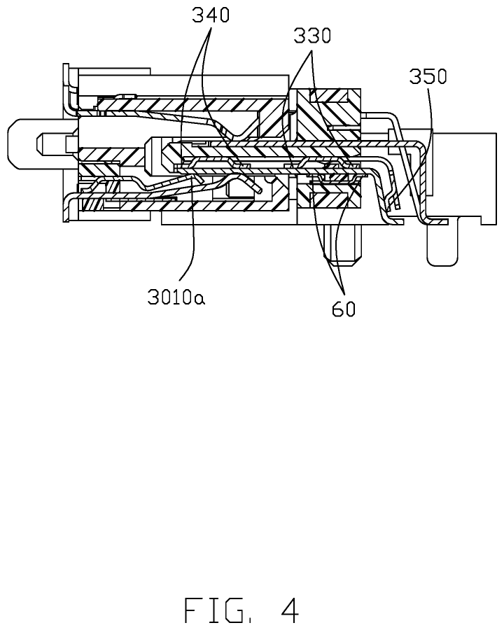

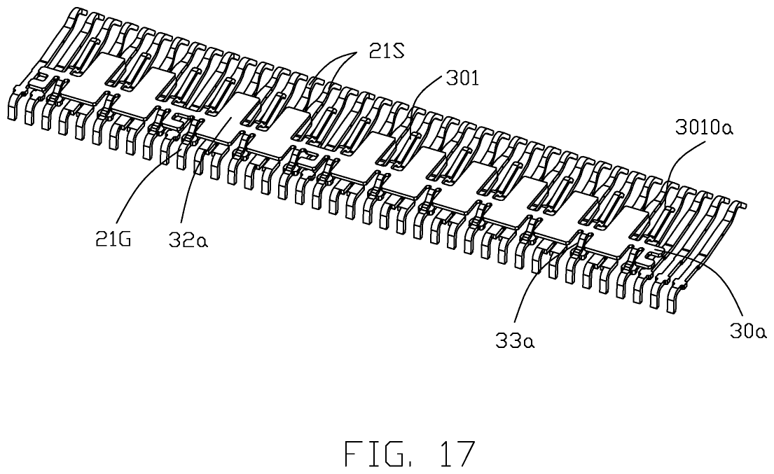

Combing with FIG. 3, each of the first terminal 21a and the second terminal 22a comprises a fixing portion 201a, a tail portion 203a extending from the fixing portion 201a backward and an elastic portion 204a extending from the fixing portion 201 forward and going into the mating slot 10, the elastic portion 204a has a contacting portion 2010a for electrically contacting with the terminals of the plug connector 100. A row of the first terminals 21a comprises pairs of signal terminals 21S and a plural of grounding terminals 21G, the first grounding member 3a is at a side of the row of first terminals 21a toward the mating slot 10, that is, the grounding member 3a is between the row of first terminals 21a and the mating slot 10. Referring to FIG. 17, similar to the first grounding member 3 of the plug connector 100, the first grounding member 3a comprises a longitudinal ridge 30a, and plural shielding portions 32a and grounding tails 33a extending from the ridges 30, each shielding portion 32a faces and shields the corresponding pair of signal terminals 21S of the first terminals 21a, each grounding tail 33a electrically contacts the corresponding grounding terminals 21G of the first terminals 21a, the shielding portion 32a of the first grounding member 3a extends from the ridge 30a forward and backward, facing the fixing portion 201a and the elastic portion 204a near the fixing portion 201a. Further combing with FIGS. 3-4, the first grounding member 3a further comprises plural elastic arms 301a extending forward from the ridge 30a and into the mating slot 10, the elastic arm 301a has a contact portion 3010a, the grounding tail 33a extends backward from the ridge 30a and to the fixing portion 201a near the tail portion 203a. So the elastic arm 301a and the grounding portion 33a locate at the front side and the rear side of the ridge 30a respectively.

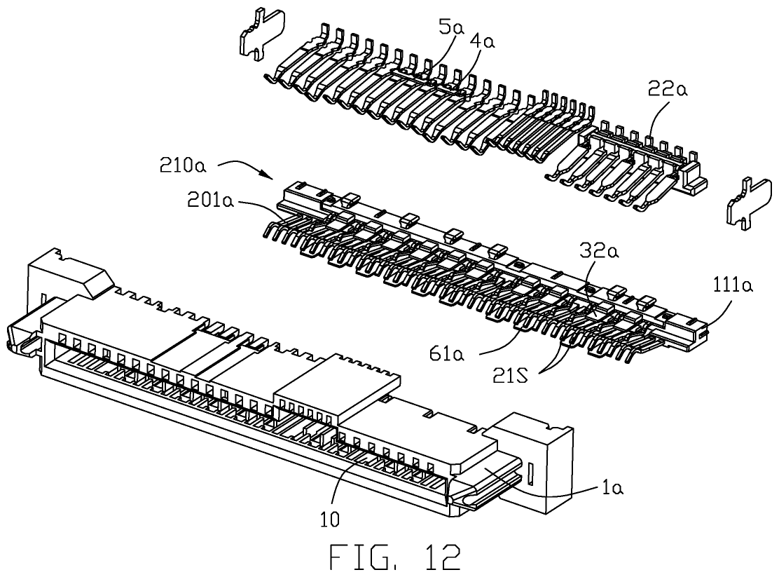

Referring to FIGS. 12-13 and 15-16, the receptacle connector 200 further comprises a second grounding member 4a, a third grounding member 5a and a fourth grounding member 6a, the second grounding member 4a has two grounding tails 41a which contact two neighbor second terminals one to one respectively. The third grounding member 5a has three grounding tails 50a which contact three adjacent second terminals 22a one to one respectively. The grounding terminals of the second terminals contact with the three grounding tails 50a of the third grounding member 5a and the two grounding tails 41a of the second grounding member 4a. The fourth grounding member 6a has a longitudinal ridge 63a, grounding tails 60a which extend backward from the longitudinal ridge 63a and shielding portions 61a extending forward from the longitudinal ridge 63a and facing the elastic portions 204a away from the fixing portion 201a. For a better shielding performance of the signal terminals 21S of the first terminals 21a, the shielding portion 32a of the first grounding member 3a and the shielding portion 61a of the fourth grounding member 6 overlap with each other near the fixing portion 201a of the first terminal 21a. The grounding tail 60a extends backward and electrically contacts with the fixing portion 201a of the grounding terminals 21G of the first terminal 21a. The power contacts of the plug connector 100, that electrically connect with the second grounding member 4 and the third grounding member 5, contact with the power contacts of the mating connector 200 that electrically connect with the second grounding member 4a and the third grounding member 5a when the plug connector 100 and receptacle connector 200 are mated.

In summary, the electrical connector of the invention can be the plug connector 100 or the receptacle connector 200, the grounding member comprises the grounding tails for contacting with the grounding terminals for mitigating the effects of resonance and the shielding portions for shielding the signal terminals.

Although the present invention has been described with reference to particular embodiments, it is not to be construed as being limited thereto. Various alterations and modifications can be made to the embodiments without in any way departing from the scope or spirit of the present invention as defined in the appended claims.

1. An electrical connector comprising:
a longitudinal housing defining a longitudinal direction;
a row of first terminals being retained in the housing and comprising plural pairs of signal terminals and plural grounding terminals;
a row of second terminals retained in the housing opposite to the row of the first terminals; and
a first grounding member retained in the housing;
wherein the first grounding member comprises a longitudinal ridge extending in the longitudinal direction, a plurality of shielding portions, and a plurality of grounding tails extending from the longitudinal ridge, the shielding portions face and shield corresponding pairs of signal terminals of the row of first terminals, respectively, spanning from a rear end to a front end of corresponding signal terminals, and the grounding tails contact corresponding grounding terminals of the row of first terminals, respectively.

2. The electrical connector as claimed in claim 1, further comprising a second grounding member and a third grounding member, wherein the second grounding member has two grounding tails which contact two corresponding grounding terminals of the row of second terminals respectively, and the third grounding member has three grounding tails which contact three corresponding grounding terminals of the row of second terminals respectively.

3. The electrical connector as claimed in claim 2, further comprising a fourth grounding member, wherein the first grounding member is located between the row of first terminals and the row of second terminals, and the fourth grounding member is located at another side of the row of first terminals.

4. The electrical connector as claimed in claim 2, wherein the first grounding member further has a front assistant ridge and a rear assistant ridge parallel to the longitudinal ridge, each of the front and rear assistant ridges has plural grounding tails extending therefrom, and the grounding tails of the longitudinal ridge, the front assistant ridge, and the rear assistant ridge contact different points of a corresponding grounding terminal of the row of first terminals.

5. The electrical connector as claimed in claim 4, wherein all the grounding tails of the longitudinal ridge, the front assistant ridge, and the rear assistant ridge extend in a lengthwise direction of the grounding terminal of the row of first terminals.

6. The electrical connector as claimed in claim 1, wherein the housing comprises a base portion and a tongue portion extending forward from the base portion, each of the first terminal and the second terminal comprises a flat portion and a tail portion, and the flat portions of the first terminals and the second terminals are exposed on opposite faces of the tongue portion respectively.

7. The electrical connector as claimed in claim 6, wherein the tail portion has a connecting portion extending downward from the flat portion and a soldering portion extending horizontally from the connecting portion, the shielding portions of the first grounding member shield the connecting portions from front ends of the flat portion of the signal terminals of the row of first terminals.

8. The electrical connector as claimed in claim 7, wherein the rear assistant ridge faces the connecting portions of the first terminals.

9. The electrical connector as claimed in claim 1, wherein the housing defines a mating slot, the row of first terminals and the row of second terminals are located at opposite sides of the mating slot, and the first grounding member is located between the row of first terminals and the row of second terminals.

10. An electrical connector comprising:
a housing comprising a mating slot and two side walls located at two sides of the mating slot;
a row of first terminals being in the housing and comprising pairs of signal terminals and grounding terminals; and
a first grounding member being in the housing and located at one side of the first terminals;
wherein the first grounding member comprises a longitudinal ridge and a plurality of shielding portions and a plurality of grounding tails extending from the longitudinal ridge, each of the shielding portions faces and shields a corresponding pair of signal terminals, and each of the grounding tails contacts corresponding grounding terminals.

11. The electrical connector as claimed in claim 10, wherein the shielding portions span forwards beyond or aligned with front ends of the signal terminals and rearwards near to rear ends of the signal terminals.

12. The electrical connector as claimed in claim 10, wherein the grounding tails comprise front grounding tails extending forwards from the longitudinal ridge and rear grounding tails extending rearwards from the longitudinal ridge, and the front grounding tail and corresponding rear tail contact same grounding terminal.

13. The electrical connector as claimed in claim 10, wherein the first grounding member comprises a front assistant ridge parallel to the longitudinal ridge and united with the shielding portions, a plurality of front grounding tails and a plurality of rear grounding tails extend oppositely from the front assistant ridge, and the front grounding tail and corresponding rear grounding tail contact same grounding terminal.

14. The electrical connector as claimed in claim 13, wherein the first grounding member comprises a rear assistant ridge parallel to the longitudinal ridge and united with the shielding portions, and a plurality of rear grounding tails extend from the rear assistant ridge and contact with the grounding terminals.

15. The electrical connector as claimed in claim 10, comprising a fourth grounding member located at another side of the first terminals, wherein the fourth grounding member comprises a longitudinal ridge, and a plurality of shielding portions, a plurality of front grounding tails, and a plurality of rear grounding tails extend from the longitudinal ridge respectively.
